(19) United States
(12) Patent Application Publication
(10) Pub. No.: US 2003/0097417 A1
(43) Pub. Date: May 22, 2003

(54) Adaptive accessing method and system for single level strongly consistent cache

(75) Inventors: Yi-Bing Lin, Hsin Chu Hsien (TW); Wen-Hsin Yang, Hsin Chu City (TW); Ying-Chuan Hsiao, Miaoli Hsien (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/067,276

(22) Filed: Feb. 7, 2002

(30) Foreign Application Priority Data
Nov. 5, 2001 (TW) 90127443

(51) Int. Cl. G06F 15/16

(52) U.S. Cl. 709/213; 711/141

(57) ABSTRACT

There is disclosed an adaptive accessing method and system for single level strongly consistent cache, capable of selecting a poll-each-read algorithm or a callback algorithm to maintain a consistency of caches between a server and at least one client. In the server, a first counter is used for measuring the number of cycles in an observed period, and a second counter is used for measuring the number of cycles that have updates in the cycles, so as to select a poll-each-read algorithm or a callback algorithm based on a ratio of the first counter and the second counter.

### BACKGROUND OF THE INVENTION

1. Field of the Invention

The present invention relates to the technical field of data consistency in cache and, more particularly, to an adaptive accessing method and system for single level strongly consistent cache.

2. Description of Related Art

Because terminal devices have become diversified and network interconnections have been widely used, the application in integrating wireless communication and the Internet generally requires a high system performance. For coping with this, cache has been proposed as means for improving system performance. As such, cache has been widely used in the current Internet application service for increasing the transmission performance of the system. As to the field of wireless communication, cache is also critical due to limited bandwidth thereof.

In the application of cache in wireless or wired communications, a consistency between both parties involving in the data communication is the most important consideration in the Internet service. In current techniques about data consistency in cache, there are two most widely used strongly consistent algorithms: the poll-each-read and callback. Referring to FIG. 1, a network communication structure according to prior art is shown. In the implementation of poll-each-read algorithm, whenever accessing a cached data entry, the client 11 has to poll the server 12 about whether the cached data entry is valid. If yes, the server 12 responses a validation affirmation. Otherwise, the server 12 sends the latest cached data entry to the user 11. In practice, the server 12 maintains a valid bit pointer cᵥ for each user 11 having the cached data entry and performs the following algorithm:

Algorithm I. Poll-Each-Read.

I.1. Entry Update (Server): When a cached data entry is updated, for every client that has the cached data entry, the server sets cᵥ to 0, wherein “0” implies that the cached data entry is invalidated.

I.2. Entry Access (Client): To access a cached data entry, a client sends an entry access message to the server. The message contains an access type bit cₐ. If the client does not have a cached data entry (either the entry is first accessed or was replaced), then cₐ is 1. In this case, the cached data entry in the server should be sent to the client. If the client has the cached data entry, then cₐ is set to 0. In this case, the cached data entry should be validated by the server.

I.3. Entry Access (Server): The server receives a cached data entry access message from a client. Let cᵥ be the validation bit for that client.

I.3.1. If the client does not have the cached data entry (i.e., cₐ=1), the server sends the entry to the client, and cᵥ is set to 1.

I.3.2. If cₐ=0 and cᵥ=0, then the server sends the cached data entry to the client. The bit cᵥ is set to 1.

I.3.3. If cₐ=0 and cᵥ=1 then the server returns validation affirmation to the client.

Referring to FIG. 2, an example of executing the poll-each-read algorithm is shown. At time t0, the client 11 desires to access a data entry not present in the cache thereof. Thus, the client 11 send a request having an access type bit of one (i.e., cₐ=1) to the server 12. When receiving the request, the server 12 sends the cached data entry to client 11 and set cᵥ to one. At time t1, the client 11 desires to access an entry present in the cache thereof. Thus, the client 11 sends a request having an access type bit of zero (i.e., cₐ=0) to the server 12. When receiving the request, the server 12 checks that the cᵥ is one and thus responses a validation affirmation to the client 11. As such, the client 11 can directly access the cached data entry in the cache. At time t2, the server 12 updates a cached data entry in the cache thereof and sets cᵥ to zero. At time t3, the client 11 desires to access an entry present in the cache thereof. Thus, the client 11 sends a request having an access type bit of zero (i.e., cₐ=0) to the server 12. When receiving the request, the server 12 sends the cached data entry to the client 11 and sets cᵥ to one.

In the implementation of callback algorithm, once a cached data entry in the server 12 is updated, the server 12 informs the client 11 to set the cached data entry to be invalid. In practice, the server 12 maintains a valid bit pointer cᵥ for each user 11 having the cached data entry and performs the following algorithm:

Algorithm II. Callback.

II.1.Entry Update (Server): When an update occurs, for every client that has the cached data entry, if cᵥ=1, the server sends an invalidation message to the client. Then the server sets cᵥ to 0.

II.2.Entry Update (Client): When the client receives the invalidation message, the cached data entry is invalidated and the storage can be reclaimed to cache another data entry. The client sends an acknowledgement message to the server.

II.3.Entry Access (Client): If the cached data entry exists, then the client uses the cached data entry. Otherwise, the client sends an entry access message to the server. Eventually, the client will receive the cached data entry from the server.

II.4.Entry Access (Server). When the server receives an entry access message from a client, it sends the cached data entry to the client. Let cᵥ be the validation bit for that client. The server sets cᵥ to 1.

Referring to FIG. 3, an example of executing the callback algorithm is shown. At time t0, the client 11 desires to access a data entry not present in cache thereof. Thus, the client 11 sends a cached data entry request to the server 12. When receiving the request, the server 12 sends the cached data entry to the client 11, and sets cᵥ to one. At time t1, the client 11 can directly access the cached data entry in its cache. At time t2, the server 12 updates the cached data entry, and sends an invalidate message to the client 11 since cᵥ is one. Then, the server 12 sets cᵥ to zero. In response, the client 11 sends an acknowledgement. At time t3 and t4, the server 12 updates the cached data entry. At time t5, the client 11 desires to access the invalid or not-existent data entry in the cache. Thus, the client 11 sends a data entry access request to the server 12. When receiving the request, the server 12 sends the cached data entry to the client 11 and sets cᵥ to one.

In view of above algorithms, it is found that, when the update frequency of the server 12 is low, the client 11 still has to poll the server 12 for accessing non-updated cached data entry in using the poll-each-read algorithm. This inevitably wastes a lot of bandwidths. On the contrary, if the update frequency of the server 12 is high, the server 12 still continuously sends invalidate message to the client 11 in using the callback algorithm even when the client 11 does not access data. This also inevitably wastes a lot of bandwidths. Therefore, it is desirable to provide a novel system and method therefor to mitigate and/or obviate the aforementioned problems.

### SUMMARY OF THE INVENTION

The object of the present invention is to provide an adaptive accessing method and system for single level strongly consistent cache, capable of dynamically selecting a poll-each-read algorithm or a callback algorithm based on the update frequency of the server and the access frequency of the client for effectively reducing the communication cost. In accordance with one aspect of the present invention, there is provided an adaptive accessing system for single level strongly consistent cache. A server is provided to have a cache, at least one cached data entry, and a first counter and a second counter corresponding to each client of each cached data entry. The first counter measures the number of cycles in an observed period, and the second counter measures the number of cycles that have updates in the cycles, wherein a cycle is defined as a period between two consecutive data accesses. At least one client is provided to connect to the server via a communication link, and each client has a cache. A dynamic adjustment module corresponding to each client of each cached data entry is provided for selecting a poll-each-read algorithm or a callback algorithm based on a ratio of the first counter and the second counter to maintain a consistency of the caches in the client and the server.

In accordance with another aspect of the present invention, there is provided an adaptive accessing method for single level strongly consistent cache. First, in the server, a first counter is used for measuring the number of cycles in an observed period, and a second counter is used for measuring the number of cycles that have updates in the cycles, wherein a cycle is defined as a period between two consecutive data accesses. Next, there is determined a ratio of the first counter and the second counter. Then, there is selected a poll-each-read algorithm or a callback algorithm based on the ratio.

Other objects, advantages, and novel features of the invention will become more apparent from the detailed description when taken in conjunction with the accompanying drawings.

### BRIEF DESCRIPTION OF THE DRAWINGS

FIG. 1 is a block diagram showing a network communication structure using cache technique;

FIG. 2 schematically illustrates an implementation of poll-each-read algorithm;

FIG. 3 schematically illustrates an implementation of callback algorithm;

FIG. 4 is a block diagram of the adaptive accessing system for single level strongly consistent cache in accordance with the present invention; and

FIG. 5 shows a comparison of communication cost among the present method, the poll-each-read algorithm and the callback algorithm.

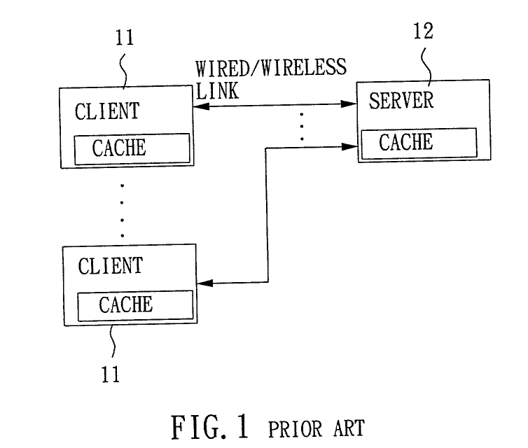

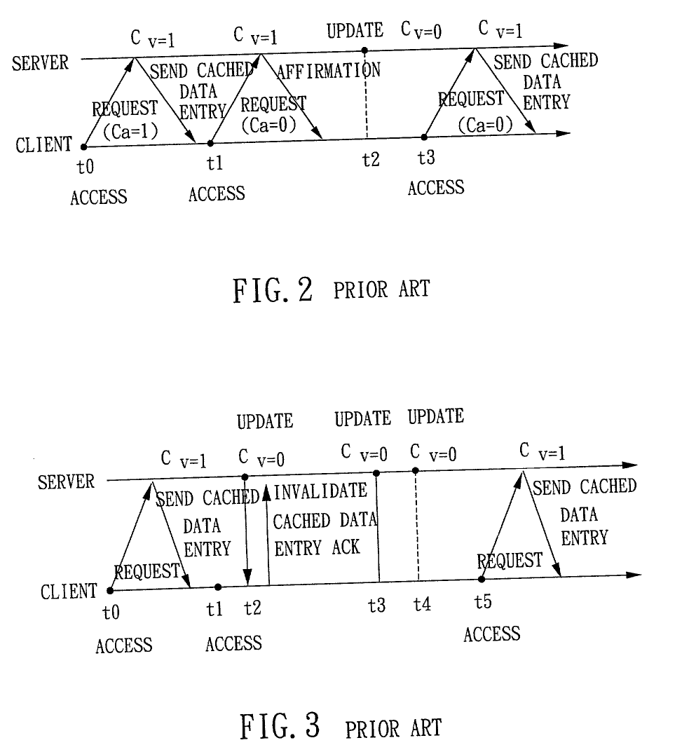

### DETAILED DESCRIPTION OF THE PREFERRED EMBODIMENT

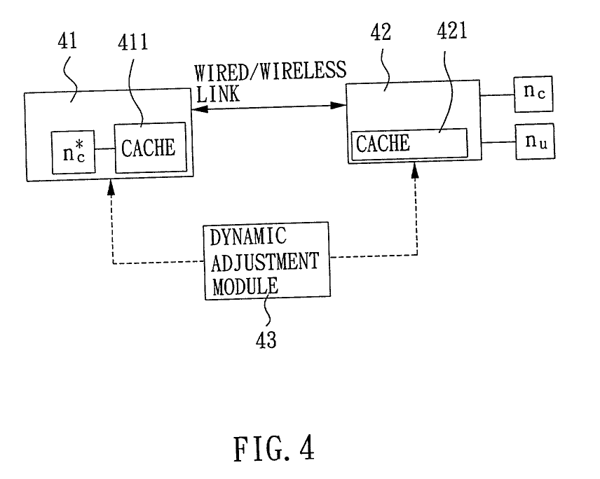

With reference to FIG. 4, there is shown a network communication structure according to the adaptive accessing method and system for single level strongly consistent cache of the present invention. As shown, a server 42 is connected to at least one client 41 via a wired or wireless communication link. The server 42 and the client 41 are provided with caches 421 and 411, respectively, for enhancing the transmission performance of the system. Furthermore, an adaptive adjustment module 43 is provided for selecting the poll-each-read algorithm or callback algorithm to maintain the data consistency of the cache. When being applied to a wireless network environment designed by WAP (wireless application protocol), the client 41 is a mobile device and the server 42 is a WAP gateway.

The dynamic adjustment module 43 is configured to maintain a consistency of cache with a minimum cost. For obtaining the time at which the dynamic adjustment module 43 selects poll-each-read or callback algorithm, it is assumed that α is the probability of at least one data update occurred between two data accesses; x is cost of sending a request, response, or message indicating whether cached data entry to be accessed is valid or not; and y is cost of transmitting the complete updated data entry. Both x and y are measured in terms of bit. In the poll-each-read algorithm, the cost of step I.2 is x; the probability of step I.3.2 is α and its cost is αy; and the probability of step I.3.3 is α and its cost is (−α)x. Hence, the communication cost of each data access in poll-each-read algorithm can be expressed as follows:

C_{I}=x+αy+(1−α)x=α(y−x)+2x (1)

In the callback algorithm, the steps II.1 to II.4 are executed only when data is updated, which has a probability of α. Thus, the total cost of steps II.1 and II.2 is 2 αx; the cost of step II.3 is αx; and the cost of step II.4 is αy. Hence, the communication cost of each data access in the callback algorithm can be expressed as follows:

C_{II}=2αx+αx+αy=α(3x+y) (2)

From equations (1) and (2), it is determined a condition for selecting the poll-each-read or callback algorithm as follows:

C_{I}>C_{II} [symbol] α(y−x)+2x>α(3x+y)

[symbol]

2x>4αx

[symbol]

α<½ (3)

That is, when α<½, the communication cost of using the callback algorithm is less. On the contrary, when α>½, the communication cost of using the poll-each-read algorithm is less.

In order to determine the value of α, a cycle is defined as a period between two consecutive data accesses. The server 42 is associated with two counters nᵤ and n_{c} for each cached data entry, wherein the counter nᵤ measures the number of the cycles that have updates in the cycles, and, the counter n_{c} measures the number of the cycles in an observed period. Hence, the probability of at least one data update occurred between two data accesses is equal to the ratio of nᵤ and n_{c}, i.e., α=nᵤ/n_{c}. These two counters nᵤ and n_{c} are operating as follows:

1. In using the poll-each-read algorithm, if the server 42 receives an cached data entry access request from user 41 (step I.3), n_{c} is incremented. If the client 41 desires to access a cached data entry existed in the cache (i.e., cₐ=0), and the server 42 has received the cached data entry access request from the client 41 and the cached data entry is invalid (i.e., cᵥ=0) (step I.3.2), nᵤ is incremented.

2. In using the callback algorithm, each cached data entry in the client 41 is associated with a third counter n_{c}* for measuring the number of accesses since the previous update. When the client 41 accesses a cached data entry in the cache (step II.3), n_{c}* in the client 41 incremented. When the server 42 updates a cached data entry (step II.1), nᵤ is incremented. If a cached data entry in the client 41 is set to be invalid (step II.2), the client 41 sends n_{c}* to the server 42, and sets n_{c}* to be zero. The server 42 adds n_{c}* to n_{c}.

3. When n_{c} is greater than a predetermined value Nc, the server 42 determines the value of α by α=nᵤ/n_{c}, and, based on equation (3), it is determined whether to use the poll-each-read algorithm or the callback algorithm. Afterwards, both nᵤ and n_{c} are set to zero.

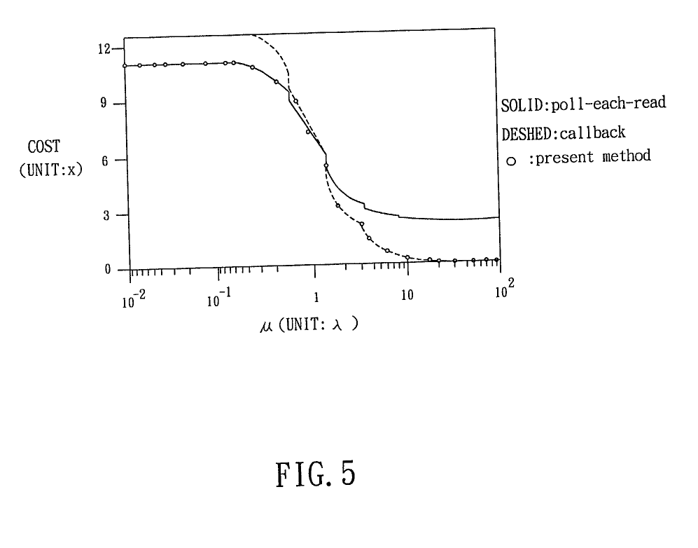

In view of above, by observing a change of α, the present invention can dynamically select the poll-each-read or callback algorithm for maintaining a data consistency of cache, thereby reducing the communication cost of the system to a minimum. With reference to FIG. 5, there is shown a comparison of communication cost among the present method, the poll-each-read algorithm and the callback algorithm under a condition of Nc=10, where μ is the counting rate of update event; λ is the counting rate of access event; and y=10x. As shown, the present method can provide a better performance.

Although the present invention has been explained in relation to its preferred embodiment, it is to be understood that many other possible modifications and variations can be made without departing from the spirit and scope of the invention as hereinafter claimed.

What is claimed is:

1. An adaptive accessing system for single level strongly consistent cache, comprising:
a server having a cache, at least one cached data entry, and a first counter and a second counter corresponding to each client of each cached data entry, the first counter measuring the number of cycles in an observed period, the second counter measuring the number of cycles that have updates in the cycles, wherein a cycle is defined as a period between two consecutive data accesses;
at least one client connected to the server via a communication link, each client having a cache; and
a dynamic adjustment module corresponding to each client of each cached data entry for selecting a poll-each-read algorithm or a callback algorithm based on a ratio of the first counter and the second counter to maintain a consistency of the caches in the client and the server.

2. The system as claimed in claim 1, wherein the dynamic adjustment module selects the poll-each-read algorithm if the ratio of the first and the second counters is greater than ½, otherwise selects the callback algorithm.

3. The system as claimed in claim 1, wherein the first counter is incremented when the poll-each-read algorithm is selected and the server receives a cached data entry access request from the client.

4. The system as claimed in claim 3, wherein, when the client desires to access a cached data entry existed in the cache thereof, and the server has received the cached data entry access request from the client and the cached data entry is invalid, the second counter is incremented.

5. The system as claimed in claim 1, wherein each cached data entry in the client has a third counter for measuring the number of accesses since a previous update, and when the callback algorithm is used and the client accesses the cached data entry in the cache thereof, the third counter is incremented.

6. The system as claimed in claim 5, wherein when the server updates the cached data entry thereof, the second counter is incremented.

7. The system as claimed in claim 6, wherein if a cached data entry in the client is set to be invalid, the client sends a value of the third counter to the server and sets the value of the third counter to be zero, and the server adds the value of the third counter to the first counter.

8. The system as claimed in claim 1, wherein when the value of the first counter is greater than a predetermined value, the server selects the poll-each-read algorithm or the callback algorithm by a ratio of the first counter and the second counter, and then sets both the first and the second counters to be zero.

9. The system as claimed in claim 1, wherein the communication link is wired link.

10. The system as claimed in claim 1, wherein the communication link is a wireless link.

11. An adaptive accessing method for single level strongly consistent cache, capable of selecting a poll-each-read algorithm or a callback algorithm to maintain a consistency of caches between a server and at least one client, the method comprising the steps of:
(A) in the server, using a first counter for measuring the number of cycles in an observed period, and a second counter for measuring the number of cycles that have updates in the cycles, wherein a cycle is defined as a period between two consecutive data accesses;
(B) determining a ratio of the first counter and the second counter; and
(C) selecting a poll-each-read algorithm or a callback algorithm based on the ratio.

12. The method as claimed in claim 11, wherein in step (C), the poll-each-read algorithm is selected if the ratio is greater than ½; otherwise the callback algorithm is selected.

13. The method as claimed in claim 11, wherein in step (A), the first counter is incremented when the poll-each-read algorithm is selected and the server receives a cached data entry access request from the client.

14. The method as claimed in claim 13, wherein when the client desires to access a cached data entry existed in the cache thereof, and the server has received the cached data entry access request from the client and the cached data entry is invalid, the second counter is incremented.

15. The method as claimed in claim 11, wherein in the step (A), each cached data entry in the client has a third counter for measuring the number of accesses since a previous update, and when the callback algorithm is used and the client accesses the cached data entry in the cache thereof, the third counter is incremented.

16. The method as claimed in claim 15, wherein when the server updates the cached data entry thereof, the second counter is incremented.

17. The method as claimed in claim 16, wherein if a cached data entry in the client is set to be invalid, the client sends a value of the third counter to the server and sets the value of the third counter to be zero, and the server adds the value of the third counter to the first counter.

18. The method as claimed in claim 11, wherein after executing the step (C), both the first and the second counters are set to zero.
